(19) United States
(12) Patent Application Publication
(10) Pub. No.: US 2015/0290559 A1
(43) Pub. Date: Oct. 15, 2015

(54) DESALTER CONTROL UNIT

(71) Applicant: FORUM US, Inc., Houston, TX (US)

(72) Inventors: Merlin Thomas COLLINS, JR., Huffman, TX (US); James Eugene BATCHELOR, Palestine, TX (US); Jonathan Carter BOUL, Cypress, TX (US)

(21) Appl. No.: 14/252,278

(22) Filed: Apr. 14, 2014

(51) Int. Cl. B01D 17/06

(52) U.S. Cl. CPC B01D 17/06

(57) ABSTRACT

A desalter system is configured to separate water from an oil/water mixture and maintain an oil/water interface within the system at acceptable levels. In one embodiment, the desalter system includes a pressure vessel, a plurality of electrodes disposed in the pressure vessel, and a control unit. The control unit is in communication with the plurality of electrodes, and may be configured to initiate electrical agitation and mechanical agitation to the oil/water mixture inside the pressure vessel in response to detecting an increased load in the plurality of electrodes due to the level of the oil/water interface within the pressure vessel.

### BACKGROUND OF THE INVENTION

1. Field of the Invention

Embodiments of the present disclosure generally relate to a control unit for a desalter.

2. Description of the Related Art

Salts (such as sodium chloride, calcium chloride, magnesium chloride, etc.) in crude oil can cause corrosion issues in piping and machinery used in oil refining processes. Therefore, desalting of crude oil is one of the initial steps performed during an oil refining process. A desalter system is used to remove salts and other water soluble impurities contained within crude oil. Since many of the salts and other water soluble impurities are dispersed within residual water in the crude oil, the removal of the residual water from the crude oil effectively removes the salts and other water soluble impurities from the crude oil. To remove the residual water from the crude oil, fresh water is mixed with the crude oil to create a water-oil mixture, also referred to herein as a water-oil emulsion. The water-oil emulsion is then subjected to a high voltage electric field where coalescence of water droplets within the water-oil emulsion occurs. Since the density of water is greater than the density of crude oil, the water droplets within the water-oil emulsion will separate from the crude oil and settle at the bottom of the desalter system. The crude oil then can be removed from the desalter system.

The addition of an electrostatic transactor or transformer at the top of the desalter system to generate the high voltage electric field promotes the separation of the crude oil and the (residual/fresh) water such that an oil/water interface is formed. The level of the oil/water interface within the desalter system however can adversely impact the performance of the electrostatic transactor or transformer by electrically overloading the electrostatic transactor or transformer, i.e., if the oil/water interface is too close to the electrostatic grid, electric current can begin leaking to ground through the water. It is difficult to monitor and control the level of the oil/water interface due to the inability to directly view the inside of the desalter system during operation.

Therefore, there is a need for new and improved methods and apparatus for monitoring and controlling the performance of desalter systems.

### SUMMARY OF THE INVENTION

In one embodiment, a desalter system comprises a pressure vessel; a plurality of electrodes disposed in the pressure vessel; a plurality of power supplies; and a control unit. The control unit comprises an autonomous component add-on situated between a control panel and power supply, which are in communication with the plurality of electrodes. The control unit is configured to initiate electrical agitation and/or mechanical agitation of the plurality of electrodes, the lowest elevation electrodes alone, and/or another transducer.

In one embodiment, a method of operating a (crude oil) desalter system comprises energizing a plurality of electrodes disposed within a pressure vessel to generate an electric field within the pressure vessel to coalesce water droplets in an oil/water mixture; detecting an increase in load, such as an increase in power consumption, in one or more of the plurality of electrodes, such as in the horizontal electrode at the lowest elevation within the pressure vessel; supplying a power spike to the plurality of electrodes, or supplying the power spike only to the horizontal electrode at the lowest elevation within the pressure vessel to electrically agitate the oil/water mixture interface; and, as necessary, supplying a resonant frequency of electric current to the plurality of electrodes, or an electric pulse to one or more additional transducers to induce vibration therein, to electrically and/or mechanically agitate the oil/water mixture interface.

In one embodiment, a desalter system comprises a pressure vessel; a plurality of electrodes disposed in the pressure vessel; and a control unit in communication with the plurality of electrodes, the control unit configured to initiate at least one of electrical agitation and mechanical agitation to an oil/water interface inside the pressure vessel.

In one embodiment, a method of operating a desalter system comprises energizing a plurality of electrodes disposed within a pressure vessel to generate an electric field in the pressure vessel to coalesce water droplets in an oil/water mixture; detecting an increase in load, such as power consumption, in the plurality of electrodes; and providing at least one of electrical agitation and mechanical agitation to the oil/water mixture inside the pressure vessel.

### BRIEF DESCRIPTION OF THE DRAWINGS

So that the manner in which the above recited features of the embodiments of the invention can be understood in detail, a more particular description of the embodiments of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a side view of a desalter system, according to one embodiment disclosed herein.

FIG. 2 illustrates an end view of the desalter system, according to the embodiment of FIG. 1 disclosed herein with certain internal components thereof shown in phantom.

FIG. 3 illustrates a plan view of an electrode grid of the desalter system, according to the embodiment of FIG. 1 disclosed herein.

FIG. 4 illustrates a side view of a desalter system, according to one embodiment disclosed herein.

### DETAILED DESCRIPTION

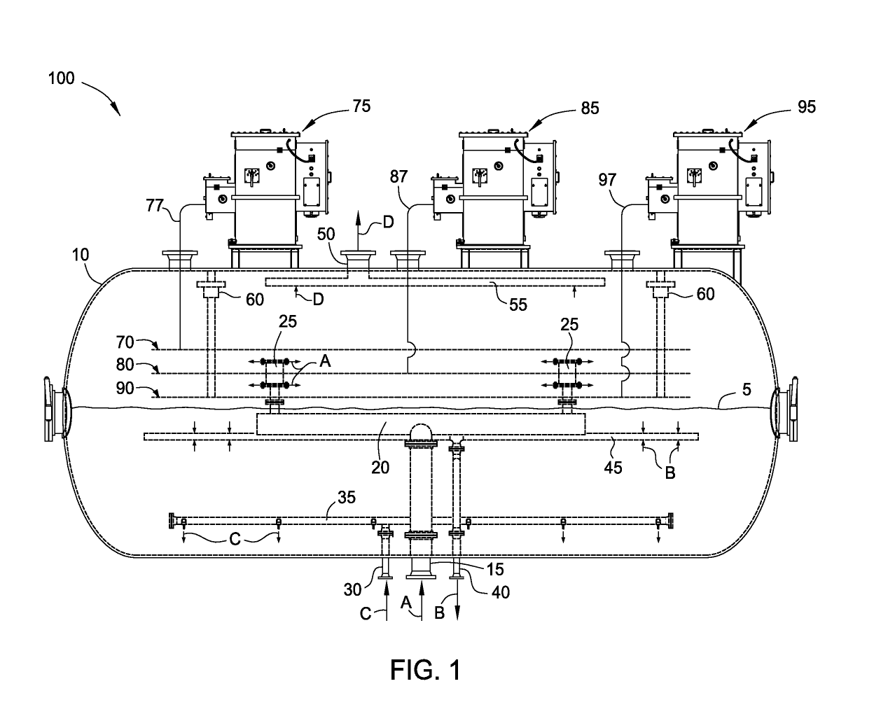

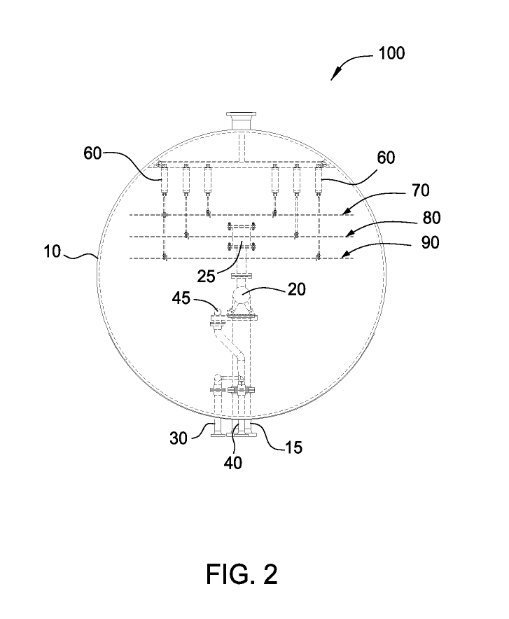

FIGS. 1 and 2 illustrate a desalter system 100 for removing various contaminants from crude oil during an oil refining process, according to one embodiment. The contaminants may include various salts, the salts including sodium chloride, calcium chloride, magnesium chloride, etc. If not removed from the crude oil, these contaminants can cause corrosion or other damage to the piping and machinery downstream from the desalter system 100 used in the oil refining process.

An exemplary system 100 includes a pressure vessel 10, having a first fluid inlet 15 thereinto, a distribution header 20 therein in fluid communication with the first fluid inlet 15, one or more distribution risers 25 extending from and in fluid communication with the distribution header 20, a second fluid inlet 30 thereinto and fluidly coupled to an injection header 35, a lower fluid outlet 40 fluidly coupled to a lower outlet header 45, and an upper fluid outlet 50 fluidly coupled to an upper outlet header 55. An oil/water mixture is supplied through the first fluid inlet 15, distributed by the distribution header 20, and injected into the pressure vessel 10 by the distribution risers 25. Oil from the oil/water mixture can be removed from the pressure vessel 10 through upper outlet header 55 and upper fluid outlet 50, while water from the oil/water mixture can be removed from the pressure vessel 10 through the lower outlet header 45 and the lower fluid outlet 40. The system 100 further includes one or more support members 60 for supporting a first plurality of electrodes 70, a second plurality of electrodes 80, and a third plurality of electrodes 90. The system 100 further includes a first control unit 75 in electrical communication with the first plurality of electrodes 70, a second control unit 85 in electrical communication with the second plurality of electrodes 80, and a third control unit 95 in electrical communication with the third plurality of electrodes 90. The first, second, and third control units 75, 85, 95 are disposed external to the pressure vessel 10 (as shown in FIG. 1 and have been omitted from FIG. 2 for clarity.

The pressure vessel 10 may comprise an elongated cylindrical housing having domed ends, although other shapes and sizes are contemplated. The pressure vessel 10 provides an enclosure for supporting the components of the system 100, interconnecting to various piping upstream and downstream of the pressure vessel 10, and enabling the fluid contents of the pressure vessel 10 to be maintained at pressures other than ambient atmospheric pressure. The pressure vessel 10 may include numerous additional inlets/outlets (not shown) to inject and remove fluids and/or solids from the pressure vessel 10 during operation and/or maintenance.

An oil/water mixture, identified by reference arrows A in FIG. 1, may be supplied through the fluid inlet 15 to the distribution header 20, distributed across the distribution header 20, and then flowed into the plurality of (two shown) distribution risers 25 wherefrom the oil/water mixture is injected into the pressure vessel 10. Each distribution riser 25 includes, in this embodiment, one or more tubular members that are coupled to and in fluid communication with the distribution header 20. The distribution riser 25 has one or more openings extending into the pressure vessel 10, which in this embodiment are disposed radially about the circumference of the tubular members for injecting the oil/water mixture into the pressure vessel 10. The oil/water mixture may include therein water droplet sizes from about 5 microns to about 20 microns. The distribution risers 25 may be arranged to inject the oil/water mixture into the pressure vessel 10 in a substantially radial direction from each distribution riser 25, and in a horizontal direction in the pressure vessel 10, as shown by reference arrows A exiting distribution riser 25 in FIG. 1. As illustrated, the distribution risers 25 inject a portion of the oil/water mixture at a location between the first plurality of electrodes 70 and the second plurality of electrodes 80. The distribution risers 25 also may additionally or only inject a portion of the oil/water mixture at a location between the second plurality of electrodes 80 and the third plurality of electrodes 90.

Although only two distribution risers 25 are illustrated, any number of distribution risers 25 (one or more) may be used with the embodiments of the invention. In one embodiment, the distribution risers 25 are configured to inject the oil/water mixture into the pressure vessel 10 at the location between the first plurality of electrodes 70 and the second plurality of electrodes 80 at an amount or flow rate that is substantially the same as the amount or flow rate that the oil/water mixture is injected at the location between the second plurality of electrodes 80 and the third plurality of electrodes 90. Various factors, such as the content of the oil/water mixture, the size of the pressure vessel 10, the size and number of electrodes, and the arrangement of the internal piping connections, such as between the first fluid inlet 15 and the distribution risers 25, within the pressure vessel 10 may determine the quantity of and/or flow rate at which the oil/water mixture is injected into the pressure vessel 10.

The water is separated from the oil/water mixture in the pressure vessel 10 using gravity drainage and electrostatic separation. Where the density of the water is greater than the density of the crude oil so that the water separates out from the crude oil due to gravity, water will settle or migrate to the bottom of the pressure vessel 10, while the crude oil will migrate to the top of the pressure vessel 10 over the water therein. In addition, the first, second, and third plurality of electrodes 70, 80, 90 may be used to independently generate electric fields that promote electrostatic separation of the water from the crude oil as further described herein.

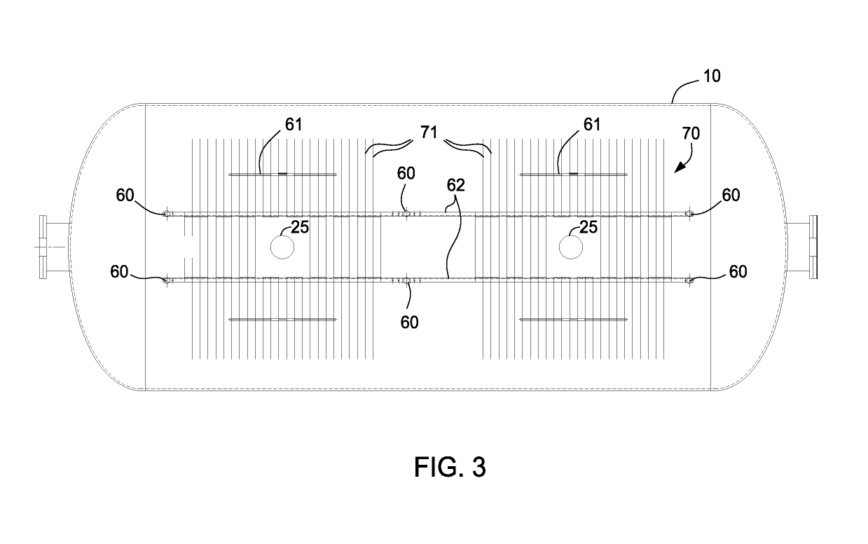

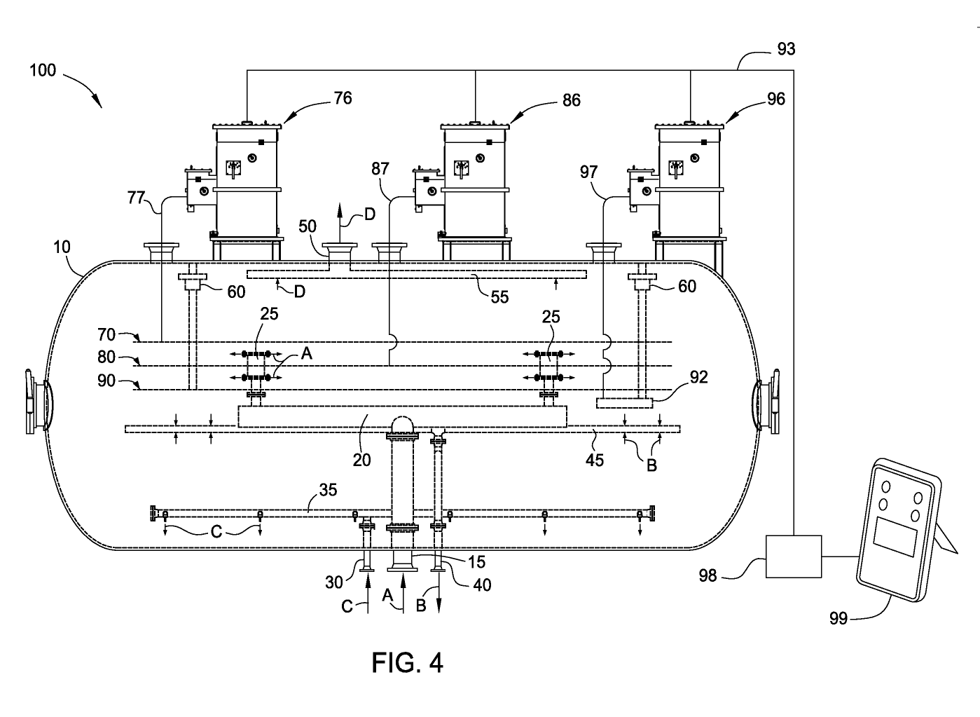

In this embodiment, each of the first, second, and third plurality of electrodes 70, 80, 90 comprise a plurality of metallic (plate-type or rod-type) members coupled together in substantially horizontal planes. FIG. 3 illustrates a plan view of the first plurality of electrodes 70 within the pressure vessel 10 situated with respect to two distribution risers 25, and the remaining components within the pressure vessel 10 have been removed for clarity. As illustrated in FIG. 3, the first plurality of electrodes 70 may comprise multiple plate-type or rod-type members 71 that are spaced apart along the longitudinal length of the pressure vessel 10. The first, second, and third plurality of electrodes 70, 80, 90 may be supported within the pressure vessel 10, such as by being secured from the ceiling of the pressure vessel 10, by one or more vertical support members 60 (only the outermost members 60 are illustrated in FIGS. 1 and 4) and disposed on one or more horizontal support members 61 (illustrated in FIG. 3) that are coupled to the vertical support members 60. One or more plate or rod supports 62 may be used to couple one or more of the plate-type or rod-type members 71 together to provide structural rigidity to the members 71 when suspended from the pressure vessel 10 by the vertical and horizontal support members 60, 61. The vertical and horizontal support members 60, 61 may comprise metal suspension hangers that are electrically insulated from the electrodes 70, 80, 90 using a Teflon-type material or coating. An alternating current voltage is applied to the first, second, and third plurality of electrodes 70, 80, 90 to generate high voltage electric fields between the first, second, and third plurality of electrodes 70, 80, 90.

A voltage may be supplied to the first, second, and third plurality of electrodes 70, 80, 90 by the first, second, and third control units 75, 85, 95 via one or more control lines 77, 87, 97, respectively. The control lines 77, 87, 97 may extend into the pressure vessel 10 through one or more sealed connections. The first, second, and third control units 75, 85, 95 may comprise power units configured to energize, e.g. supply a voltage to, the first, second, and third plurality of electrodes 70, 80, 90. A varying electric field gradient may be generated across the electrodes 70, 80, 90 using the control units 75, 85, 95. An electric field may be generated by forming an electric potential difference, e.g. a difference in voltage, between the first and second plurality of electrodes 70, 80, an electric potential difference formed between the second and third plurality of electrodes 80, 90, and/or an electric potential difference formed between the third plurality of electrodes 90 and an oil/water interface 5 (which acts as ground when the pressure vessel 10 is grounded) that is formed within the pressure vessel 10 as the water separates from the oil/water mixture.

According to one example, an electric field may be generated within the pressure vessel 10 using the first and/or second plurality of electrodes 70, 80 under the control of the first and/or second control units 75, 85 that has an intensity, e.g. voltage, greater than or less than an electric field generated within the pressure vessel 10 using the second and/or third plurality of electrodes 80, 90 under the control of the second and/or third control units 85, 95. Each of the first, second, and third plurality of electrodes 70, 80, 90 may be energized to generate an electric field within the pressure vessel 10 that has an intensity that is the same as, less than, or greater than an electric field generated by another of the first, second, and third plurality of electrodes 70, 80, 90. Although only three horizontal planes of electrodes are illustrated, the system 100 may comprise any number or arrangement of horizontal electrodes. By imposing an alternating current on the electrodes 70, 80, 90 at different potentials as well as among the different electrodes, an electric field gradient is imposed between adjacent electrodes. This alternating current gradient helps coalesce the smaller water droplets in the oil/water mixture or emulsion into larger sized droplets, which then will settle under the force of gravity to the bottom of the pressure vessel 10.

Water, identified by reference arrows B, which has been separated from the oil/water mixture, flows into the lower outlet header 45 and may be removed from the pressure vessel 10 through the lower fluid outlet 40 when the lower fluid outlet 40 is open, i.e. the pressure therein is less than the pressure at the lower outlet header 45. The lower outlet header 45 is positioned below the distribution risers 25. To clean the pressure vessel 10 after a period of desalting of crude oil, other fluids, identified by reference arrows C, such as cleaning/backwash fluids may be supplied through the second fluid inlet 30 and injected into the pressure vessel 10 by the injection header 35 to clean and remove undesirable accumulates on the surfaces within the pressure vessel 10. The injection header 35 is positioned near the bottom of the pressure vessel 10. Oil, identified by reference arrows D, separated from the oil/water mixture flows into the upper outlet header 55 and is removed from the pressure vessel 10 through the upper fluid outlet 50 for further processing. The upper outlet header 55 is positioned above the distribution risers 25.

When the oil/water mixture is exposed to the electric fields generated by the energized electrodes 70, 80, 90, the water droplets in the mixture coalesce to form larger water droplets. Specifically, as each water droplet in the oil/water mixture flows through the electric fields generated within the pressure vessel 10 between the energized electrodes 70, 80, 90, the charged electric field causes each water droplet to vibrate at the frequency of the alternating current voltage supplied to the energized electrodes 70, 80, 90 by the power supplies of the control units 75, 85, 95. The vibration of the water droplets results in collisions of water droplets, resulting in the formation of large drops of water by the coalescence of many smaller water droplets. The large water droplets thus formed have sufficient mass to fall through the oil/water mixture and to settle at, or migrate to, the bottom of the pressure vessel 10. Coalescence of small water droplets is enhanced by increasing the electric field intensity. However, a high intensity electric field may potentially rupture or redistribute larger coalesced water droplets back into smaller water droplets. Thus, according to one embodiment, the control units 75, 85, 95 are capable of controlling the intensity of each electric field generated within the pressure vessel 10 by controlling the voltage supplied to the electrodes 70, 80, 90 by the power supplies of the control units 75, 85, 95, such that an electric field is generated within the pressure vessel 10 between the electrodes 70 and 80 to coalesce smaller water droplets into larger/heavier water droplets that will gravitate downward and has an intensity that is greater than an electric field generated within the pressure vessel 10 between the electrodes 80 and 90 to prevent rupture or redistribution of the larger water droplets back into smaller water droplets and thereby enhance coalescence of the larger water droplets.

This combination of electrostatic separation followed by gravity separation causes an oil/water interface 5 to form within the pressure vessel 10. The water-soluble salts and impurities in the water stay in the water droplets that are separated from the oil/water mixture and settles at or to the bottom of the pressure vessel 10 below the oil/water interface 5, where the water is continuously discharged (withdrawn) from the pressure vessel 10 through the lower outlet header 45 and the lower fluid outlet 40. The discharge rate of the water from the pressure vessel 10 can be controlled, such as by a liquid level controller (not shown), so that the oil/water interface is maintained at a level below the third plurality of electrodes 90 or lowest elevation horizontal electrode grid. The crude oil above the oil/water interface 5 from which the water is separated is discharged from the pressure vessel 10 through the upper outlet header 55 and the upper fluid outlet 50. Although a liquid level controller can be used to maintain the level of the oil/water interface 5 within the pressure vessel 10, in the event of a failure of the liquid level controller, a desalting system operator cannot see inside the pressure vessel 10 to confirm that the level of the oil/water interface 5 is acceptable.

The resolution and level of the oil/water interface 5 within the pressure vessel 10 can adversely impact the performance and sizing of electrostatic separation equipment, e.g. the electrodes 70, 80, 90. The electrodes 70, 80, 90 should be large enough to generate electric fields that can coalesce water droplets in the oil/water mixture as the oil/water mixture is injected into the pressure vessel 10 to also help maintain the oil/water interface 5 at a level below the lowest electrode grid, such as the third plurality of electrodes 90. Contact of the oil/water interface 5 with any of the electrodes 70, 80, 90 can lead to frequent arcing and create a ground path from the electrodes 70, 80, 90 to the pressure vessel 10, thereby grounding the voltage supplied to the electrodes 70, 80, 90 by the power supplies in the control units 75, 85, 95 and disruption of the electric fields, which will minimize and prevent water droplet coalescence and allow large amounts of oil to be lost and removed with the water through the lower fluid outlet 40, as well as the need to inject additional chemicals into the pressure vessel 10 to assist with oil/water separation.

To maintain the oil/water interface 5 at an acceptable level within the pressure vessel 10, the third control unit 95 may comprise a controller, such as a “Kick Amp Responder”™ sold by Forum Energy Technologies. The controller of the third control unit 95 includes one or more programmable logic units, electronic processing units, memory, mass storage devices, input/output controls, power supplies, clocks, cache, control panels, and/or display units. The third control unit 95 may include an integral control panel configured to integrate, process, and provide local visual indications of pressures, temperature, and/or flow rates of fluids into and out of the pressure vessel 10, and/or control additional level control devices within the pressure vessel 10. The control panel may also be configured to allow a desalting system operator to set desired operating parameters, such as mixing rates of flows through fluid control devices, such as valves and pumps (not shown) upstream from the pressure vessel 10 for supplying fluids into the pressure vessel 10 conducive to effective operation of the system 100. The third control unit 95 may also include real-time, and/or remote, electrostatic separation monitoring and logging that can be accessed by one or more desalting system operators via wired or wireless communication.

The controller in the third control unit 95 is configured to detect an increase in load (e.g. power consumption necessary to maintain a fixed voltage) in the third plurality of electrodes 90, i.e. the lowest layer of the electrodes in the pressure vessel 10 and thus the electrodes closest to the oil/water interface 5. An increase in load in the third plurality of electrodes 90 is generated when the oil/water interface 5 approaches or contacts the third plurality of electrodes 90 and thereby creates a ground path between the third plurality of electrodes 90 and the pressure vessel 10. The increase in load is caused by the difference in the conductivity of the water at or below the oil/water interface 5 compared to the conductivity of the more separated oil region at or above the oil/water interface 5. The controller in the third control unit 95 is configured to initiate electrical and/or mechanical agitation in response to detecting an increase in load in the third plurality of electrodes 90.

The controller in the third control unit 95, as needed, may initiate electrical agitation of the fluid adjacent the third plurality of electrodes 90 by supplying one or more power spikes (e.g. voltage increases) to the third plurality of electrodes 90 to break up any ground path created by contact with the water. The controller in the third control unit 95, as needed, may initiate mechanical agitation by simultaneously supplying one or more resonant frequencies (resonant to one or more of the electrodes 70, 80, and/or 90, in particular the lowermost electrode closest to the oil/water interface 5) that tend to physically vibrate the electrodes 70, 80, and/or 90 and/or by causing one or more additional transducers (such as transducer 92 illustrated in FIG. 4) to physically agitate the region below the third plurality of electrodes 90 to break up any ground path created by contact with the water and re-establish the electrical field to resume water droplet coalescence near the oil/water interface 5. In one embodiment, only the control unit that energizes the lowest elevation horizontal electrodes may include the controller to initiate the additional electrical and/or mechanical agitation, while the other electrodes are energized by alternating current power units. In one embodiment, any of the control units that energize any of the horizontal electrode grids may include the controller to initiate the additional electrical and/or mechanical agitation.

FIG. 4 illustrates the system 100 according to one embodiment. A (autonomous) control unit 98 can be integrated into existing desalter systems between a control panel 99 and the power supplies of first, second, and third power units 76, 86, 96 via control lines 93. The control unit 98 includes a controller that functions substantially the same as the controller of the third control unit 95 described above. Specifically, the control unit 98 can detect an increase in load in any of the plurality of electrodes 70, 80, 90, and in response initiate electrical and/or mechanical agitation of the oil/water mixture as described herein. The control unit 98 may include an autonomous standalone area rated enclosure (which may be certified for use in hazardous areas) between the control panel 99 and the power supplies of the first, second, and third power units 76, 86, 96.

The control panel 99 may be configured to integrate, process, and provide local visual indications of and/or control additional level control devices within the pressure vessel 10. The control panel 99 may also be configured to set desired operating parameters, such as mixing rates of fluid flowing through control devices, such as valves and pumps (not shown) upstream from the pressure vessel 10 for supplying fluids into the pressure vessel 10, conducive to effective operation of the system 100. The control panel 99 and/or the control unit 98 may include real-time, and/or remote, electrostatic separation monitoring and logging that can be accessed via wired or wireless communication.

Further illustrated in FIG. 4, is a transducer 92, such as an electro-mechanical type transducer, supported by the vertical support member 60 at a position below the third plurality of electrodes 90 (or lowest electrode grid). The transducer 92 may be in communication with the controller 98 and the third power unit 96 via control line 97, 93. Upon detecting an increase in load in the third plurality of electrodes 90, the controller 98, based upon an operator set or system set change or level of load, sends an electrical signal to the transducer 92 and thereby generate an electric pulse to the third plurality of electrodes 90, and/or the transducer 92, to physically vibrate the third plurality of electrodes 90 and/or the transducer 92 to thereby agitate the region below the third plurality of electrodes 90 to re-establish water droplet coalescence near the oil/water interface 5. Although only one transducer 92 is illustrated, one or more transducers 92 may be used. In one embodiment, one or more transducers 92 may be coupled to and/or configured to physically vibrate the first, second, and/or third plurality of electrodes 70, 80, 90. In one embodiment, the transducer 92 may be another grid-like structure that is similar to any of the first, second, and/or third plurality of electrodes 70, 80, 90, located at an elevation below the lowest plurality of electrodes, which can be physically vibrated to mechanically agitate the oil/water interface 5.

Any of the control units 75, 85, 95, 98 may be in communication with one or more sensors disposed within or external to the pressure vessel 10 to measure one or more operating characteristics of the system 100. The operating characteristics may include the load/current/voltage in the first, second, and third plurality of electrodes 70, 80, 90, the level of the oil/water interface 5 within the pressure vessel 10, and/or fluid flow rates into and out of the pressure vessel 10. Any of the control units 75, 85, 95, 98 can continuously monitor, log, and control the energizing of the first, second, and third plurality of electrodes 70, 80, 90 to optimize the performance of the system 100.

In operation, an oil/water mixture, identified by reference arrows A may be supplied through the first fluid inlet 15, flowed to and distributed by the distribution header 20, and injected into the pressure vessel 10 by the distribution risers 25. The oil/water mixture may be injected radially and initially directed along a substantially horizontal plane between the first and second plurality of electrodes 70, 80, and/or between the second and third plurality of electrodes 80, 90 at the same or different flow rates and/or amounts. The first and/or second plurality of electrodes 70, 80 may be energized to generate a high intensity electric field, such that water droplets in the oil/water mixture coalesce to form larger water droplets in the region between the first and second plurality of electrodes 70, 80. The larger, heavier water droplets tend to gravitate downward and separate from the oil. The second and/or third plurality of electrodes 80, 90 may be energized to generate a lower intensity electric field, such that the large water droplets continue to coalesce to form even larger water droplets and further separate out from the oil, but the electric field intensity is sufficiently low so as to not cause breakdown of these larger water droplets into smaller water droplets. As the water separates from the oil, the oil/water interface 5 forms so that oil can be removed from the upper fluid outlet 50, while water can be removed from the lower fluid outlet 40.

In the event that the oil/water interface 5 begins to approach or contact the third plurality of electrodes 90, the controller in the control units 95, 98 detects an increase in load across the third plurality of electrodes 90. In response to the increased load, the controller supplies one or more power spikes to the third plurality of electrodes 90, e.g. rapid increases and decreases in voltage, to agitate the oil/water interface 5 and re-establish water droplet coalescence. Alternatively or in addition, the controller may simultaneously supply one or more triggering mechanisms, such as a resonant frequency, across the third plurality of electrodes 90 that will cause the third plurality of electrodes 90 to physically vibrate, and thereby agitate the oil/water interface 5 and re-establish water droplet coalescence. Alternatively or in addition, the control unit 98 may trigger the transducer 92 to electrically and/or mechanically agitate the same as described above. The first and second control units 75, 85 also may be configured to similarly initiate electrical and/or mechanical agitation to the first and second plurality of electrodes 70, 80 as needed.

In one embodiment, the control units 75, 85, 95, 98 may be configured to automatically initiate the necessary amount of electrical and/or mechanical agitation when detecting an increase in load in the first, second, and/or third plurality of electrodes 70, 80, 90. In one embodiment, the control units 75, 85, 95, 98 may be configured to provide an indication to an operator that electrical and/or mechanical agitation may be needed due to an increase in load. In one embodiment, the control units 75, 85, 95, 98 may be configured to control other devices/valves, such as level control devices to remove fluid from the pressure vessel 10 or chemical injection devices to inject fluids into the pressure vessel 10, to maintain the level of the oil/water interface 5 within acceptable levels.

While the foregoing is directed to embodiments of the invention, other and further embodiments of the invention may be devised without departing from the basic scope thereof, and the scope thereof is determined by the claims that follow.

1. A desalter system, comprising:
a pressure vessel;
a plurality of electrodes disposed in the pressure vessel; and
a control unit in communication with the plurality of electrodes, the control unit configured to initiate at least one of electrical agitation and mechanical agitation to an oil/water interface inside the pressure vessel.

2. The system of claim 1, wherein the plurality of electrodes comprise a first plurality of electrodes, which are disposed above a second plurality of electrodes, which are disposed above a third plurality of electrodes.

3. The system of claim 2, wherein the control unit is configured to supply a power spike to the third plurality of electrodes to provide electrical agitation.

4. The system of claim 2, wherein the control unit is configured to supply a resonant frequency to the third plurality of electrodes to provide mechanical agitation.

5. The system of claim 2, wherein the control unit is configured to activate a transducer to provide mechanical agitation.

6. The system of claim 2, wherein the control unit comprises a first control unit in communication with the first plurality of electrodes, a second control unit in communication with the second plurality of electrodes, and a third control unit in communication with the third plurality of electrodes.

7. The system of claim 6, further comprising a distribution riser configured to inject an oil/water mixture into the pressure vessel at a location between the first and second plurality of electrodes, and at a location between the second and third plurality of electrodes.

8. A method of operating a desalter system, comprising:
energizing a plurality of electrodes disposed within a pressure vessel to generate an electric field to coalesce water droplets in an oil/water mixture;
detecting an increase in load in the plurality of electrodes; and
providing at least one of electrical agitation and mechanical agitation to the oil/water mixture inside the pressure vessel.

9. The method of claim 8, wherein providing electrical agitation comprises supplying a power spike to the plurality of electrodes.

10. The method of claim 8, wherein providing mechanical agitation comprises supplying a resonant frequency to the plurality of electrodes to physically vibrate the electrodes.

11. The method of claim 8, wherein providing mechanical agitation comprises activating a transducer to physically vibrate and agitate the oil/water mixture.

12. The method of claim 8, further comprising simultaneously providing both electrical and mechanical agitation to the oil/water mixture in response to detecting the increase in load.

13. The method of claim 8, further comprising automatically providing the at least one electrical and mechanical agitation to the oil/water mixture in response to detecting the increase in load.

14. The method of claim 8, further comprising monitoring a level of an oil/water interface formed within the pressure vessel.

15. The method of claim 8, wherein the plurality of electrodes comprise a first plurality of electrodes, which are disposed above a second plurality of electrodes, which are disposed above a third plurality of electrodes.

16. The method of claim 15, further comprising detecting the increase in load in the third plurality of electrodes using a control unit.

17. The method of claim 16, further comprising initiating the at least one electrical and mechanical agitation to the third plurality of electrodes using the control unit to agitate the oil/water mixture.

18. The method of claim 17, further comprising vibrating the third plurality of electrodes to mechanically agitate the oil/water mixture.
